(19) United States
(12) Patent Application Publication
(10) Pub. No.: US 2012/0069474 A1
(43) Pub. Date: Mar. 22, 2012

(54) MAGNETIC HEAD, MAGNETIC HEAD ASSEMBLY, AND MAGNETIC RECORDING/REPRODUCING APPARATUS

(75) Inventors: Masayuki TAKAGISHI, Tokyo (JP); Susumu Hashimoto, Tokyo (JP); Hitoshi Iwasaki, Tokyo (JP)

(73) Assignee: KABUSHIKI KAISHA TOSHIBA, Tokyo (JP)

(21) Appl. No.: 13/071,681

(22) Filed: Mar. 25, 2011

(30) Foreign Application Priority Data
Sep. 17, 2010 (JP) 2010-208833

(51) Int. Cl. G11B 5/48; G11B 5/33

(52) U.S. Cl. 360/244; 428/810; 428/815; G9B/5.104; G9B/5.147; 977/700

(57) ABSTRACT

According to one embodiment, a magnetic head includes a reproducing section. The reproducing section has a medium facing surface facing a magnetic recording medium and detects a direction of magnetization recorded in the medium. The reproducing section includes a first magnetic pinned layer, a second magnetic pinned layer, and a magnetic free layer. Directions of magnetizations of the first and second magnetic pinned layers are pinned. The second magnetic pinned layer is stacked with the first magnetic pinned layer in a first direction parallel to the medium facing surface. The magnetic free layer is provided between the first and second magnetic pinned layers. A direction of magnetization of the magnetic free layer is changeable. A length of the magnetic free layer along a second direction perpendicular to the medium facing surface is shorter than lengths of the first and second magnetic pinned layers along the second direction.

### CROSS-REFERENCE TO RELATED APPLICATIONS

This application is based upon and claims the benefit of priority from the prior Japanese Patent Application No. 2010-208833, filed on Sep. 17, 2010; the entire contents of which are incorporated herein by reference.

### FIELD

Embodiments described herein relate generally to a magnetic head, a magnetic head assembly, and a magnetic recording/reproducing apparatus.

### BACKGROUND

Magnetoresistance effect elements are used for magnetic heads (for example, MR head: magnetoresistive head). A magnetoresistive head is mounted in a magnetic recording/reproducing apparatus and configured to read information from magnetic recording mediums, such as a hard disk drive. In order to improve the performance (storage density) of a hard disk, a magnetic head having a low resistance and a high output is required. While spatial resolution increases further especially for improvement in storage density, a technology of obtaining a magnetic head having a high output and a low resistance is important.

### BRIEF DESCRIPTION OF THE DRAWINGS

FIG. 1A to FIG. 1D are schematic views illustrating a magnetic head according to a first embodiment;

FIG. 2 is a schematic perspective view illustrating the magnetic head according to the first embodiment;

FIG. 3 is a schematic perspective view illustrating a head slider on which the magnetic head according to the first embodiment is mounted.

FIG. 4 is a graph illustrating characteristics of the magnetic head;

FIG. 5A to FIG. 5D are schematic view illustrating another magnetic head according to the first embodiment;

FIG. 6A to FIG. 6D are schematic views illustrating another magnetic head according to the first embodiment;

FIG. 7 is a graph illustrating characteristics of the magnetic head;

FIG. 8A to FIG. 8D are schematic views illustrating another magnetic head according to the first embodiment;

FIG. 9A to FIG. 9D are schematic views illustrating another magnetic head according to the first embodiment;

FIG. 10A to FIG. 10D are schematic views illustrating another magnetic head according to the first embodiment;

FIG. 11A to FIG. 11D are schematic cross-sectional views in order of processes illustrating a method for manufacturing a magnetic head according to a second embodiment;

FIG. 12A and FIG. 12B are schematic cross-sectional views in order of processes illustrating the method for manufacturing the magnetic head according to the second embodiment;

FIG. 13 is a flowchart illustrating the method for manufacturing the magnetic head according to the second embodiment;

FIG. 14 is a schematic perspective view illustrating a magnetic recording/reproducing apparatus according to a third embodiment; and

FIG. 15A and FIG. 15B are schematic perspective views illustrating part of the magnetic recording/reproducing apparatus according to the third embodiment.

### DETAILED DESCRIPTION

In general, according to one embodiment, a magnetic head includes a reproducing section. The reproducing section has a medium facing surface facing a magnetic recording medium. The reproducing section is configured to detect a direction of magnetization being recorded in the magnetic recording medium. The reproducing section includes a first magnetic pinned layer, a second magnetic pinned layer, and a magnetic free layer. A direction of magnetization of the first magnetic pinned layer is pinned. The second magnetic pinned layer is stacked with the first magnetic pinned layer in a first direction parallel to the medium facing surface. A direction of magnetization of the second magnetic pinned layer is pinned. The magnetic free layer is provided between the first magnetic pinned layer and the second magnetic pinned layer. A direction of magnetization of the magnetic free layer is changeable. A length of the magnetic free layer along a second direction perpendicular to the medium facing surface is shorter than a length of the first magnetic pinned layer along the second direction and shorter than a length of the second pinned layer along the second direction,

Embodiments will now be described with reference to the drawings.

The drawings are schematic or conceptual; and the relationships between the thickness and width of portions, the proportions of sizes among portions, etc., are not necessarily the same as the actual values thereof. The dimensions and the proportions may be illustrated differently among the drawings, even for identical portions.

In the specification and the drawings of the application, components similar to those described in regard to a drawing thereinabove are marked with like reference numerals, and a detailed description is omitted as appropriate.

### First Embodiment

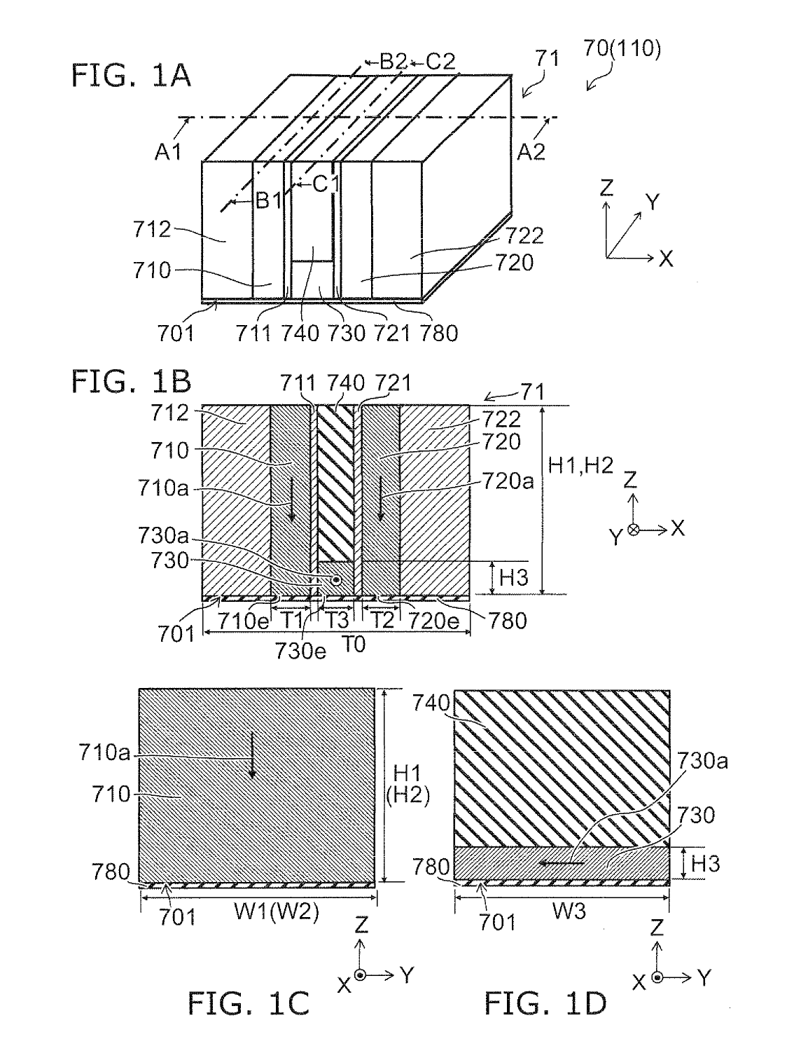

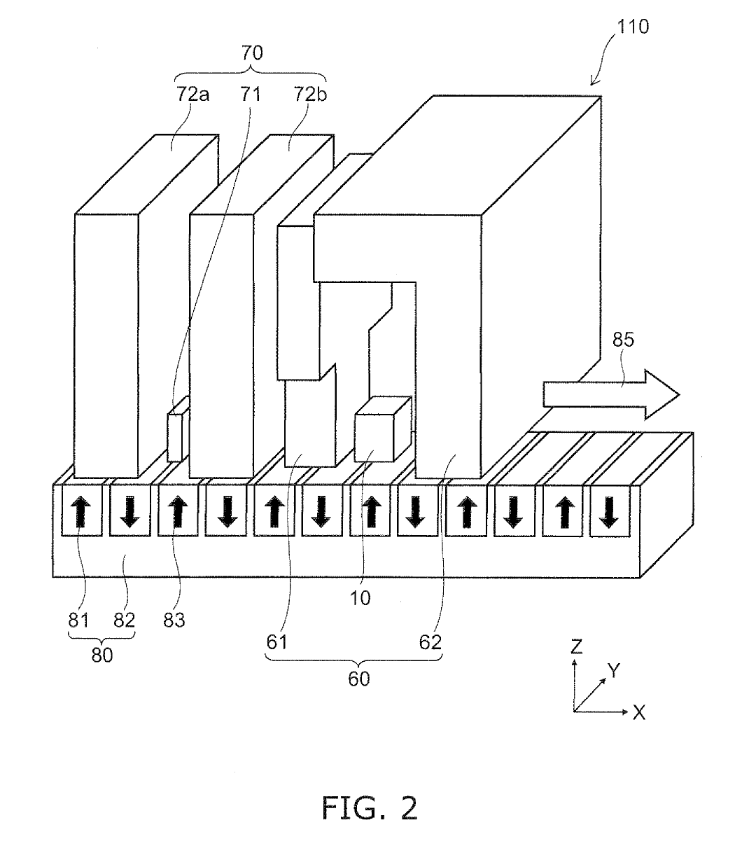

FIG. 1A to FIG. 1D are schematic views illustrating the configuration of a magnetic head according to a first embodiment.

Namely, FIG. 1A is a schematic perspective view; FIG. 1B is a cross-sectional view along line A1-A2 of FIG. 1A; FIG. 1C is a cross-sectional view along line B1-B2 of FIG. 1A; and FIG. 1D is a cross-sectional view along line C1-C2 of FIG. 1A.

FIG. 2 is a schematic perspective view illustrating the configuration of the magnetic head concerning the first embodiment.

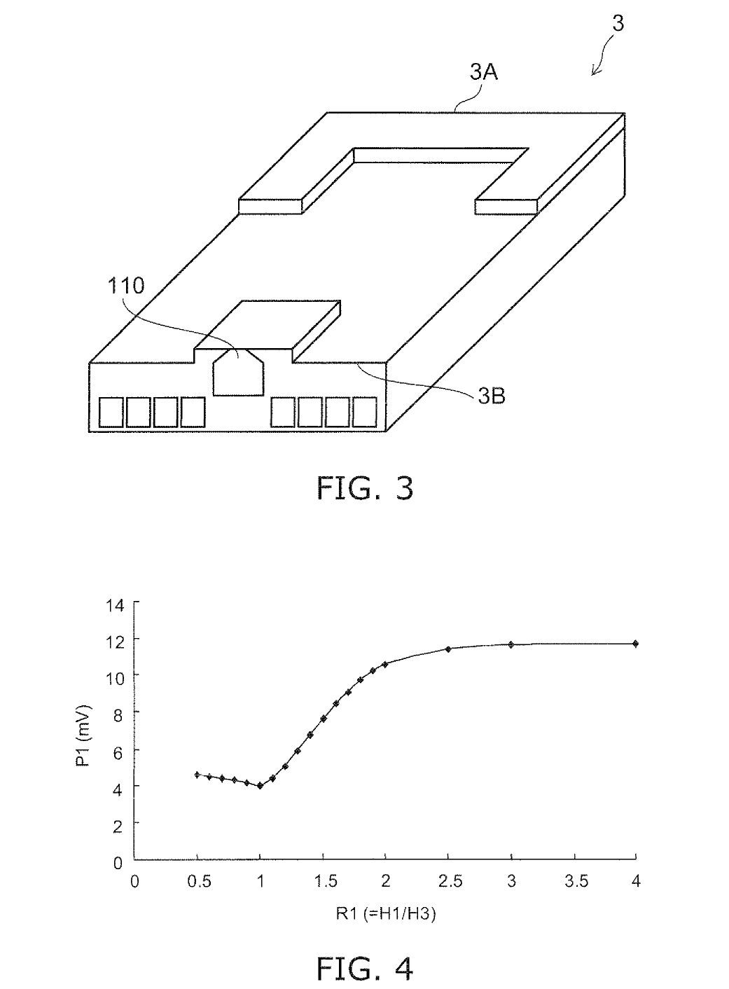

FIG. 3 is a schematic perspective view illustrating the configuration of a head slider on which the magnetic head according to the first embodiment is mounted.

First, the outline of the configuration of the magnetic head according to this embodiment and the outline of operations thereof are explained with reference to FIG. 2 and FIG. 3.

As illustrated in FIG. 2, a magnetic head 110 includes a reproducing section 70 (reproducing head section). Further, the magnetic head 110 can include a recording section 60 (recording head section).

The recording section 60 includes, for example, a main magnetic pole 61 and a return path (shield) 62. In the magnetic head 110, the recording section 60 can further include a portion which functions to assist a recording process of a spin torque oscillator 10 and the like. In other words, the recording section 60 of the magnetic head 110 can have any configurations.

The reproducing section 70 includes a magnetoresistance effect element 71, a first magnetic shield 72a, and a second magnetic shield 72b. The magnetoresistance effect element 71 is provided between the first magnetic shield 72a and the second magnetic shield 72b. As described below, the first magnetic shield 72a and the second magnetic shield 72b are provided as necessary and can be omitted in some cases.

Each component of the reproducing section 70 recited above and each component of the recording section 60 recited above are separated by an insulator, not shown, of, for example, alumina.

As illustrated in the FIG. 3, the magnetic head 110 is mounted on a head slider 3. Al₂O₃/TiC etc., for example, is used for the head slider 3.

The head slider 3 moves relatively to a magnetic recording medium 80 while floating or contacting on the magnetic recording medium 80, such as a magnetic disk.

The head slider 3 has, for example, an air inflow side 3A and an air outflow side 36. The magnetic head 110 is disposed on a side surface or the like of the air outflow side 36 of the head slider 3. Thereby, the magnetic head 110 mounted on the head slider 3 moves relatively to the magnetic recording medium 80 while floating or contacting on the magnetic recording medium 80.

As illustrated in the FIG. 2, the magnetic recording medium 80 has, for example, a medium substrate 82 and a magnetic recording layer 81 provided on the medium substrate 82. The magnetization 83 of the magnetic recording layer 81 is controlled by a magnetic field applied by the recording section 60. Thereby, the recording operation is performed. At this time, the magnetic recording medium 80 moves relatively to the magnetic head 110 along a direction of a medium moving direction 85.

The reproducing section 70 is disposed opposing the magnetic recording medium 80. The magnetic recording medium 80 moves relatively to the magnetic head 110 along the direction of the medium moving direction 85, and the reproducing section 70 detects the direction of the magnetization 83 of the magnetic recording layer 81. Thereby, the reproducing operation is performed.

FIG. 1A to FIG. 1D illustrate the configuration of the reproducing section 70.

In these figures, the first magnetic shield 72a and the second magnetic shield 72b are omitted.

As illustrated in FIG. 1A to FIG. 1D, the magnetic head 110 according to this embodiment includes the reproducing section 70. The reproducing section 70 has a medium facing surface 701 (ABS: Air Bearing Surface) which opposes the magnetic recording medium 80. The reproducing section 70 detects the direction of the magnetization 83 recorded on the magnetic recording medium 80.

The reproducing section 70 includes a first magnetic pinned layer 710, a second magnetic pinned layer 720, and a magnetic free layer 730. The first magnetic pinned layer 710, the second magnetic pinned layer 720, and the magnetic free layer 730 are included in the magnetoresistance effect element 71.

The direction of the magnetization (first magnetization 710a) of the first magnetic pinned layer 710 is pinned.

The second magnetic pinned layer 720 is stacked with the first magnetic pinned layer 710 along a first direction parallel to the medium facing surface 701. The direction of the magnetization (second magnetization 720a) of the second magnetic pinned layer 720 is pinned.

In the specification of the application, in addition to the case where multiple layers are directly overlaid, “stacking” also includes the case where multiple layers are overlaid with other layers inserted therebetween.

The magnetic free layer 730 is provided between the first magnetic pinned layer 710 and the second magnetic pinned layer 720. The direction of the magnetization of the magnetic free layer 730 is changeable.

Here, a direction from the first magnetic pinned layer 710 toward the second magnetic pinned layer 720 is taken as an X-axis direction. A direction perpendicular to the medium facing surface 701 is taken as a Z-axis direction. A direction perpendicular to the X-axis direction and perpendicular to the Z-axis direction is taken as a Y-axis direction.

In this specific example, the X-axis direction is parallel to the medium facing surface 701. At this time, “parallel” includes not only a state in which the X-axis direction is strictly parallel to the medium facing surface 701, but also a state in which the X-axis direction is inclined from the medium facing surface 701 with a small angle. For example, the X-axis direction may incline to the medium facing surface 701 with plus or minus ten degrees or less.

The X-axis direction corresponds to the first direction.

The X-axis direction aligns along, for example, a down track direction (the medium moving direction 85). The Y-axis direction aligns, for example, along a cross track direction (the track width direction). The recording section 60 aligns with the reproducing section 70 along the X-axis direction, for example. For example, the medium moving direction 85 may incline to the X-axis direction with an angle of plus or minus 20 degrees or less, depending on the relative position of the reproduced magnetic recording medium 80 to be reproduced. Therefore, at this time, “align” includes a state in which the X-axis direction (the direction from the first magnetic pinned layer 710 to the second magnetic pinned layer 720) is inclined from medium moving direction 85 with an angle of plus or minus 20 degrees or less, in addition to a state in which the X-axis direction is strictly parallel to the medium moving direction 85.

For the first magnetic pinned layer 710 and the second magnetic pinned layer 720, ferromagnetic materials, such as, for example, Fe, Co, Ni, a FeCo alloy, and a FeNi alloy, can be used.

For the magnetic free layer 730, ferromagnetic materials, such as, for example, Fe, Co, Ni, a FeCo alloy, and a FeNi alloy, can be used.

In this specific example, a first conductive layer 711 is provided between the first magnetic pinned layer 710 and the magnetic free layer 730. A second conductive layer 721 is provided between the second magnetic pinned layer 720 and the magnetic free layer 730. For the first conductive layer 711 and the second conductive layer 721, conductive materials of non-magnetics, such as copper, for example, can be used.

In this specific example, a first antiferromagnetic layer 712 is provided on a side of the first magnetic pinned layer 710 opposite to the magnetic free layer 730. In other words, the first magnetic pinned layer 710 is provided between the first antiferromagnetic layer 712 and the magnetic free layer 730. The direction of the magnetization (the first magnetization 710a) of the first magnetic pinned layer 710 is pinned by the first antiferromagnetic layer 712. A second antiferromagnetic layer 722 is provided on a side of the second magnetic pinned layer 720 opposite to the magnetic free layer 730. In other words, the second magnetic pinned layer 720 is provided between the second antiferromagnetic layer 722 and the magnetic free layer 730. The direction of the magnetization (the second magnetization 720a) of the second magnetic pinned layer 720 is pinned by the second antiferromagnetic layer 722. For the first antiferromagnetic layer 712 and the second antiferromagnetic layer 722, antiferromagnetic materials, such as PtMn, PdPtMn, IrMn, and RuRhMn, for example, can be used.

A voltage (bias voltage) is applied to the magnetic free layer 730 via the first conductive layer 711 and the second conductive layer 721. Specifically, for example, the bias voltage is applied between the first antiferromagnetic layer 712 and the second antiferromagnetic layer 722, and a current flows in the magnetic free layer 730 via the first magnetic pinned layer 710, the first conductive layer 711, the second magnetic pinned layer 720, and the second conductive layer 721. Thereby, the direction of the magnetization 83 of the magnetic recording medium 80 is detected by detecting resistance in the magnetoresistance effect element 71, and the reproducing operation is performed.

As described below, the first conductive layer 711 and the second conductive layer 721 are provided as necessary and can be omitted in some cases. For example, the first magnetic pinned layer 710 and the second magnetic pinned layer 720 can achieve the function of the first conductive layer 711 and the second conductive layer 721.

In this specific example, a protection layer 780 is provided on the medium facing surface 701 of the reproducing section 70. For the protection layer 780, for example, carbon, which is a non-magnetic material, is used. The thickness of the protection layer 780 is set to, for example, not less than 1 nanometer (nm) and not more than 3 nm. The protection layer 780 is provided as necessary and omitted in some cases.

In the reproducing section 70 of the magnetic head 110 according to this embodiment, an end surface on a side of a stacked structure body of the first magnetic pinned layer 710, the magnetic free layer 730, and the second magnetic pinned layer 720 facing the magnetic recording medium 80 becomes the medium facing surface 701.

An end 710e of the first magnetic pinned layer 710 on a side of the medium facing surface 701, an end 720e of the second magnetic pinned layer 720 on the side of the medium facing surface 701, and an end 730e of the magnetic free layer 730 on the side of the medium facing surface 701 are located in a plane including the medium facing surface 701. In other words, in the reproducing section 70, the first magnetic pinned layer 710, the second magnetic pinned layer 720, and the magnetic free layer 730 are disposed proximal to the magnetic recording medium 80. Thereby, the magnetization 83 of the magnetic recording medium 80 in the reproducing section 70 can be efficiently detected.

The thickness T1 (a length along the X-axis direction) of the first magnetic pinned layer 710 is set to, for example, not less than 1 nm and not more than 10 nm. The thickness T1 is set to 4 nm in this specific example.

The thickness T2 (a length along the X-axis direction) of the second magnetic pinned layer 720 is set to, for example, not less than 1 nm and not more than 10 nm. The thickness T2 is set to 4 nm in this specific example.

The thickness T3 (a length along the X-axis direction) of the magnetic free layer 730 is set to, for example, not less than 1 nm and not more than 10 nm, The thickness T3 is set to 5 nm in this specific example.

As illustrated in FIG. 1B, the thickness TO along the X-axis direction of the magnetoresistance effect element 71 corresponds to the sum of the thickness T1 of the first magnetic pinned layer 710, the thickness T2 of the second magnetic pinned layer 720, the thickness T3 of the magnetic free layer 730, the thickness of the first conductive layer 711, the thickness of the second conductive layer 721, the thickness of the first antiferromagnetic layer 712, and the thickness of the second antiferromagnetic layer 722.

In the reproducing section 70, for example, the magnetoresistance effect element 71 is provided between the first magnetic shield 72a and the second magnetic shield 72b, and the thickness T0 of the magnetoresistance effect element 71 corresponds to a gap length.

In this specific example, the length (a first magnetic pinned layer width W1) along the Y-axis direction of the first magnetic pinned layer 710 is the same as the length (a second magnetic pinned layer width W2) along the Y-axis direction of the second magnetic pinned layer 720. The length (a magnetic free layer width W3) of the magnetic free layer 730 along the Y-axis direction is the same as the first magnetic pinned layer width W1 and the second magnetic pinned layer width W2. However, as described below, the magnetic free layer width W3 may be set smaller than the first magnetic pinned layer width W1 and the second magnetic pinned layer width W2.

The first magnetic pinned layer width W1 and the second magnetic pinned layer width W2 are set to, for example, not less than 4 nm and not more than 200 nm. In this specific example, the first magnetic pinned layer width W1 and the second magnetic pinned layer width W2 are 12 nm.

The magnetic free layer width W3 is set to be not more than the first magnetic pinned layer width W1 and the second magnetic pinned layer width W2. In this specific example, the magnetic free layer width W3 is also set to 12 nm.

As illustrated in FIG. 1B, in this specific example, the direction of the magnetization (the first magnetization 710a) of the first magnetic pinned layer 710 is parallel to the direction of the magnetization (the second magnetization 720a) of the second magnetic pinned layer 720. At this time, “parallel” includes a state in which an angle between the direction of the first magnetization 710a and the direction of the second magnetization 720 is plus or minus 20 degrees or less, in addition to a state in which the direction of the first magnetization 710a is strictly parallel to the direction of the second magnetization 720a.

Specifically, the direction of the first magnetization 710a is parallel to the Z-axis direction. The direction of the second magnetization 720a is parallel to the Z-axis direction. For example, the angle between the direction of the first magnetization 710a and the Z-axis direction may be plus or minus 20 degrees or less. For example, the angle between the direction of the second magnetization 720a and the Z-axis direction may be plus or minus 20 degrees or less.

However, the embodiment is not limited thereto. As described below, for example, the direction of the first magnetization 710a may be parallel to the Y-axis direction and the direction of the second magnetization 720a may be parallel to the Y-axis direction.

The easy axis (a magnetization easy axis 730a) of the magnetization of the magnetic free layer 730 intersects with the direction of the magnetization (the first magnetization 710a) of the first magnetic pinned layer 710 and intersects with the direction of the magnetization (the second magnetization 720a) of the second magnetic pinned layer 720.

Specifically, the magnetization easy axis 730a of the magnetic free layer 730 is orthogonal to the direction of the magnetization (the first magnetization 710a) of the first magnetic pinned layer 710 and is orthogonal to the direction of the magnetization (the second magnetization 720a) of the second magnetic pinned layer 720. At this time, “orthogonal” includes a state of near orthogonal in addition to strict orthogonal. An angle between the direction of the magnetization easy axis 730a of the magnetic free layer 730 and the direction of the first magnetization 710a is set to, for example, not less than 60 degrees and not more than 120 degrees. An angle between the direction of the magnetization easy axis 730a of the magnetic free layer 730 and the direction of the second magnetization 720a is set to, for example, not less than 60 degrees and mot more than 120 degrees. Thus, the magnetization easy axis 730a of the magnetic free layer 730 is perpendicular to the direction of the magnetization of the first magnetic pinned layer 710 and perpendicular to the direction of the magnetization of the second magnetic pinned layer 720. At this time, “perpendicular” includes a state in which the magnetization easy axis 730a is strictly perpendicular to the direction of the magnetization of the first magnetic pinned layer 710 and the magnetization easy axis 730a is strictly perpendicular to the direction of the magnetization of the second magnetic pinned layer 720. In addition, “perpendicular” includes a state in which these angles are ranged in the angles recited above.

In the reproducing section 70 of the magnetic head 110 according to this embodiment, the length (a magnetic free layer height H3) along the second direction (the Z-axis direction) perpendicular to the medium facing surface 701 of the magnetic free layer 730 is shorter than the length (a first magnetic pinned layer height H1) of the first magnetic pinned layer 710 along the second direction and shorter than the length (a second magnetic pinned layer height H2) of the second magnetic pinned layer 720 along the second direction.

The first magnetic pinned layer height H1 and the second magnetic pinned layer height H2 are set to, for example, not less than the height (the magnetic free layer height H3) of the magnetic free layer 730 and not more than 200 nm. In this specific example, the first magnetic pinned layer height H1 and the second magnetic pinned layer height H2 are 100 nm.

The magnetic free layer height H3 is set to, for example, not less than 2 nm and less than 8 nm. In this specific example, the magnetic free layer height H3 is set to 5 nm.

Thereby, in the reproducing section 70 (i.e., in the magnetoresistance effect element 71), a high output and a low resistance are obtained.

The first magnetic pinned layer 710 and the second magnetic pinned layer 720 may be replaced mutually. At this time, the first antiferromagnetic layer 712 and the second antiferromagnetic layer 722 are replaced mutually in accordance with the replacement of the first magnetic pinned layer 710 and the second magnetic pinned layer 720. The first conductive layer 711 and the second conductive layer 721 are replaced mutually.

In the magnetic head 110, an insulating layer 740 of a nonmagnetic material is provided between the first magnetic pinned layer 710 and the second magnetic pinned layer 720 (specifically between the first conductive layer 711 and the second conductive layer 721) and in a portion where the magnetic free layer 730 is not provided.

For the insulating layer 740, oxidization silicone etc. is used, for example. The insulating layer 740 electrically divides the first magnetic pinned layer 710 (specifically the first conductive layer 711) and the second magnetic pinned layer 720 (specifically the second conductive layer 721).

FIG. 4 is a graph illustrating characteristics of the magnetic head.

Namely, FIG. 4 illustrates simulation results of output P1 when the ratio R1 (R1=H1/H3) of the first magnetic pinned layer height H1 to the magnetic free layer height H3 is changed. Here, the output P1 is an isolated reproduction output.

In this simulation, the second magnetic pinned layer height H2 was set to be the same as the first magnetic pinned layer height H1, and the magnetic free layer height H3 was set to be constant by 5 nm. The output P1 was simulated when the first magnetic pinned layer height H1 and the second magnetic pinned layer height H2 were changed. The horizontal axis of FIG. 4 represents the ratio R1, and the vertical axis represents the output P1. In this simulation, GMR was assumed as the principle of MR. It was assumed that the MR effect arises in the interface of the first magnetic pinned layer 710 and the magnetic free layer 730, in the interface of the second magnetic pinned layer 720 and the magnetic free layer 730, and in the layer of the first magnetic pinned layer 710, in the layer of the second magnetic pinned layer 720, and in the layer of the magnetic free layer 730. Further, it was assumed that the magnetic free layer width W3 is 10 nm, the thickness T1 of the first magnetic pinned layer 710 and the thickness T2 of the second magnetic pinned layer 720 are 10 nm, and the thickness T3 of the magnetic free layer 730 is 5 nm in the element. The maximum value of a bias current was assumed to be determined by the temperature of the MR element, and the maximum value of the bias current was set to a value when the temperature of the MR element is 90 degrees C.

As illustrated in the FIG. 4, when the ratio R1 is smaller than 1, i.e., when the magnetic free layer height H3 is larger than the first magnetic pinned layer height H1, the output P1 is small. For example, the output P1 is 4 millivolts (mV) to 4.5 mV. When the ratio R1 becomes 1 or more, the output P1 increases. When the ratio R1 becomes 2 or more, the output P1 becomes almost constant, e.g., 10 mV to 12 mV.

In other words, when the magnetic free layer height H3 becomes smaller than the first magnetic pinned layer height H1, the output P1 increases, and when the magnetic free layer height H3 becomes ½ or less of the first magnetic pinned layer height H1, the output P1 becomes substantially saturated.

Thus, when the magnetic free layer height H3 becomes smaller than the first magnetic pinned layer height H1, the output P1 increases.

In the magnetic head 110 according to this embodiment, a new configuration is employed in which the magnetic free layer height H3 is smaller than the first magnetic pinned layer height H1 and the area of the magnetic free layer 730 is smaller than the area of the first magnetic pinned layer 710 and the second magnetic pinned layer 720.

In this configuration, the area of the magnetic free layer 730 is smaller than the area of the first magnetic pinned layer 710 and the second magnetic pinned layer 720. Therefore, the thermal diffusion efficiency in the magnetoresistance effect element 71 is improved. Thereby, a large current can be passed, and consequently the output can be increased.

Further, the area of the interface of the magnetic free layer 730 and the first magnetic pinned layer 710 and the area of the interface of the magnetic free layer 730 and the second magnetic pinned layer 720 become smaller than the cross-section area (cross-section area when cutting in a Y-Z plane perpendicular to the direction of current flowing) of the first magnetic pinned layer 710 and the second magnetic pinned layer 720. Thereby, the rate (change rate in resistance) of the resistance change in the above-mentioned interface, in which the MR effect mainly arises, to the resistance of whole of the magnetoresistance effect element 71 can be increased.

The resistance of whole of the magnetoresistance effect element 71 can be decreased while increasing the change rate in resistance. This is based on the effect of the confine of the current. In other words, the area of the magnetic free layer 730 is smaller than the area of the first magnetic pinned layer 710 and the second magnetic pinned layer 720. Therefore, the current flowing between the first magnetic pinned layer 710 and the second magnetic pinned layer 720 is confined in the magnetic free layer 730. Thereby, the resistance can be decreased while increasing the change rate in resistance.

In a CPP (Current Perpendicular to Plane)—CPP (Current-Confined-Path)—GMR (giant magneto resistive effect) element, a current pass in a non-magnetic middle layer in the element is confined. On the other hand, in the configuration according to this embodiment, a current pass is confined by decreasing the whole area of the magnetic free layer 730.

The element size of the magnetoresistance effect element 71 becomes small as the storage density in the magnetic recording medium 80 increases. In connection with that, the bias voltage which can be applied tends to decrease. Since the resistance of the MR head increases when the element size becomes smaller, the decrease of the resistance of the element is required.

At this time, in the magnetic head 110 according to the embodiment, by the new configuration, the increase of the current by improvement in the thermal diffusion efficiency, the increase of the change rate in resistance, and the decrease of the resistance can be realized.

In the reproducing section 70, the MR effect mainly arises at the interface of the magnetic free layer 730 and the magnetic pinned layer. In the magnetic head 110 according to the embodiment, by using two magnetic pinned layers, the interface of the magnetic free layer 730 and the magnetic pinned layer where the MR effect mainly arises becomes double the case of using the magnetic pinned layer of one sheet. Therefore, in this embodiment, the whole output (the maximum resistance change) based on the GMR effect is at least 1.5 times the configuration using a magnetic pinned layer of one sheet.

A spin torque noise can be also suppressed by the new configuration of the magnetic head 110 according to the embodiment.

In other words, by using two magnetic pinned layers of the first magnetic pinned layer 710 and the second magnetic pinned layer 720, both of a transmitting torque from one magnetic pinned layer and a reflecting torque by the other magnetic pinned layer are applied to the magnetic free layer 730. The torque directions become mutually reverse. Thereby, the total amount of torque becomes smaller than the case of using one magnetic pinned layer.

For operating a magnetoresistance effect film of a generally-known spin valve structure as a reproducing element, a bias current (sense current) is passed substantially perpendicularly to the film surface. In this case, by passing the bias current, conduction electrons also flows in an opposite direction to the bias current. In that case, the spin angular momentum of a magnetic film passed first flows into a magnetic film passed next via the spin angular momentum of the conduction electrons, and torque is given to the magnetization.

For example, in the case where the conduction electrons flow from the magnetic pinned layer to the magnetic free layer, the angular momentum when passing the magnetic pinned layer gives torque to the magnetization in the magnetic free layer. In the case where the conduction electrons flow from the magnetic free layer to the magnetic pinned layer, the angular momentum when passing the magnetic free layer gives torque to the magnetization in the magnetic pinned layer.

The torque generated as described above is a so-called spin transfer torque. This spin transfer torque may have a big influence on the magnetization of the magnetic free layer to the reproducing element used in hard disks etc., and may be a big noise in the magnetoresistance effect film.

In other words, the delivery efficiency of the spin torque is greatly dependent on the direction of current and the relative angle between the magnetic free layer magnetization and the magnetic pinned layer magnetization. In the case where the bias current flows from the magnetic free layer to the magnetic pinned layer (i.e., the conduction electrons move from the magnetic pinned layer to the magnetic free layer), the delivery efficiency is improved when the relative angle between magnetizations of both layers is near 180 degrees. Conversely, in the case where the bias current flows from the magnetic pinned layer to the magnetic free layer (i.e., the conduction electrons move from the magnetic free layer to the magnetic pinned layer), the delivery efficiency is improved when the relative angle between magnetizations of both layers is near 0 degree.

The former case occurs because the spin of the conduction electrons is parallel to the magnetization of the magnetic pinned layer and is anti-parallel to the magnetization of the magnetic free layer. Therefore, the conduction electrons having a spin parallel to the magnetization of the magnetic pinned layer penetrates the magnetic pinned layer to reach the magnetic free layer. The latter case occurs because the spin of the conduction electrons is parallel to the magnetization of the magnetic pinned layer and to the magnetization of the magnetic free layer. Therefore, the conduction electrons having a spin anti-parallel to the magnetization of the magnetic pinned layer are reflected at the magnetic pinned layer to move into the magnetic free layer.

Thus, the magnetization of the magnetic free layer is caused to receive torque resulting from the spin taken into the magnetic free layer as described above. Thereby, the magnetization of the magnetic free layer moves randomly and becomes unstable. This may result in noise and may lead to an insufficient reproducing output. By changing the passing direction of the bias current in consideration of the relative angle between the magnetic free layer magnetization and the magnetic pinned layer magnetization to decrease the delivery efficiency of the spin torque described above, the delivery efficiency of the spin torque can be decreased to a certain degree. However, the spin transfer torque also depends on the bias current value and becomes remarkable with increase of the bias current value. Therefore, the influence of the spin transfer torque cannot be sufficiently decreased by only changing the passing direction of the bias current.

On the other hand, if the bias current value is small, the spin transfer torque can be reduced without taking into consideration of the passing direction of the bias current. Specifically, if the bias current value is about 10⁷ (A/cm²) or less, the influence of the spin transfer torque can be reduced.

However, the bias current value is greatly related to the characteristics required of the magnetoresistance effect element. If the bias current value increases, a large reproducing output can be obtained even if the MR ratio of the magnetoresistance effect element is small. Therefore, in the case where the bias current value is about 10⁷ (A/cm²) or less, it is required that the MR ratio of the magnetoresistance effect element is high enough for obtaining a sufficient reproducing output. On the other hand, it is considered that it is difficult to sufficiently satisfy such a MR ratio with the TMR (tunneling magneto resistive effect) element and GMR element which are known.

On the other hand, in the magnetic head 110 according to the embodiment, the torque direction of the transmitting torque and the torque direction of the reflecting torque become mutually reverse by the new configuration using two magnetic pinned layers. Thereby, the influence of the spin transfer torque is suppressed. Thereby, the reduction of the reproducing output resulting from the spin transfer torque is suppressed, and a high reproducing output is obtained.

Furthermore, in the magnetic head 110 according to the embodiment, the degradation of the SN ratio by a heat magnetic noise can also be suppressed.

The magnetization of a magnetic body always receives turbulence due to heat, and the magnetization direction of the magnetic free layer and the magnetization direction of the magnetic pinned layer are always changed randomly in connection with that. This causes the heat magnetic noise. It is thought that this noise is inversely proportional to the square root of the volume of the magnetic body. For example, in a conventionally-known reproducing head, in the storage density of 5 terabits per 1 square inch, the heat magnetic noise is estimated to be equivalent to the medium induced noise which is the main cause of the reproducing head. This becomes a problem in practice.

On the other hand, in the magnetic head 110 according to the embodiment, by increasing the height H1 of the first magnetic pinned layer 710 and the height H2 of the second magnetic pinned layer 720, the volume of the magnetic pinned layer becomes large. Thereby, the degradation of the SN ratio by the heat magnetic noise can be suppressed. Further, as described below, by making the length (the magnetic free layer width W3) of the magnetic free layer 730 along the Y-axis direction longer than the length (the magnetic free layer height H3) of the magnetic free layer 730 along the Z-axis direction, the anisotropic magnetic field of the magnetic free layer 730 is increased, and the degradation of the SN ratio by the heat magnetic noise can be suppressed.

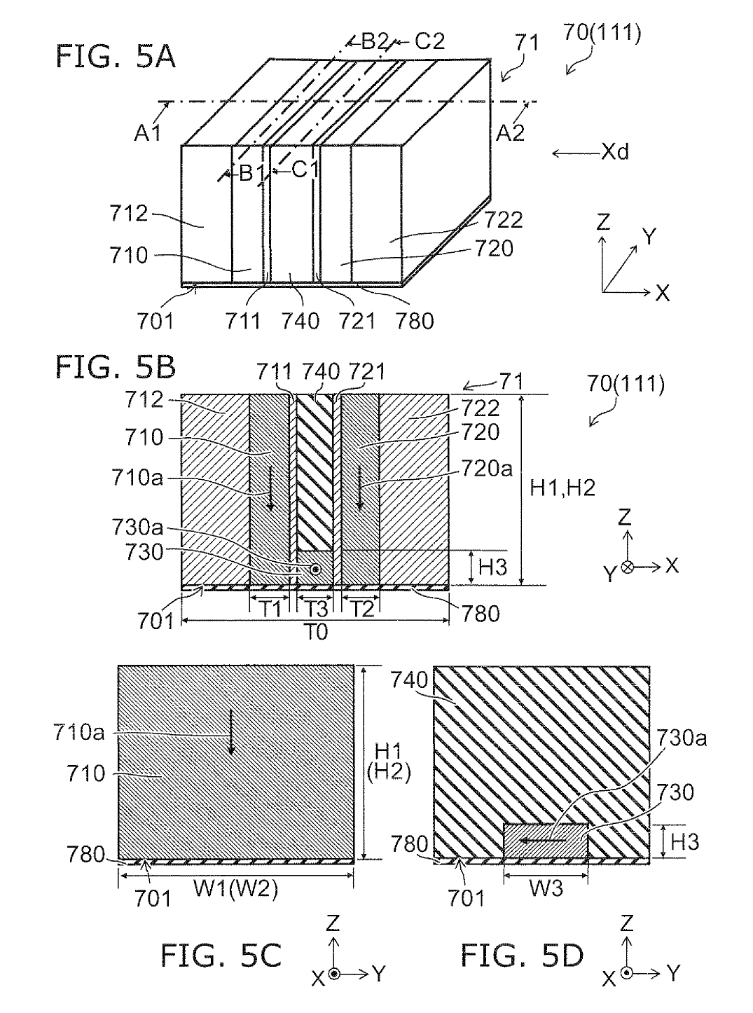

FIG. 5A, to FIG. 5D is a schematic view illustrating the configuration of another magnetic head according to the first embodiment.

Namely, FIG. 5A is a schematic perspective view; FIG. 5B is a cross-sectional view along line A1-A2 of FIG. 5A; FIG. 5C is a cross-sectional view along line B1-B2 of FIG. 5A; and FIG. 5D is a cross-sectional view along line C1-C2 of FIG. 5A.

As illustrated in FIG. 5A to FIG. 5D, in the reproducing section 70 of the magnetic head 111 according to this embodiment, the width of the magnetic free layer 730 is narrowed. Otherwise, the configuration of the magnetic head 111 is similar to that of the magnetic head 110, and a description is therefore omitted.

In the magnetic head 111, the length (the magnetic free layer width W3) of the magnetic free layer 730 along the third direction (the Y-axis direction) perpendicular to the first direction (the X-axis direction) and the second direction (the Z-axis direction) is shorter than the length (the first magnetic pinned layer width W1) along the Y-axis direction of the first magnetic pinned layer 710 and shorter than the length (the second magnetic pinned layer width W2) along the Y-axis direction of the second magnetic pinned layer 720.

In this specific example, the first magnetic pinned layer width W1 and the second magnetic pinned layer width W2 are set to 50 nm, and the magnetic free layer width W3 is set to 10 nm.

Thereby, the increase of the current by improvement in the thermal diffusion efficiency and the increase of change rate in resistance, and the decrease of the resistance are promoted further. In other words, a high output and a low resistance can be achieved further. Also, the degradation of the SN ratio by the heat magnetic noise is suppressed further.

It is preferable that the length (the magnetic free layer width W3) of the magnetic free layer 730 along the Y-axis direction is longer than the length (the magnetic free layer height H3) of the magnetic free layer 730 along the Z-axis direction. Thereby, the anisotropic magnetic field of the magnetic free layer 730 is increased, and the degradation of the SN ratio by the heat magnetic noise can be suppressed.

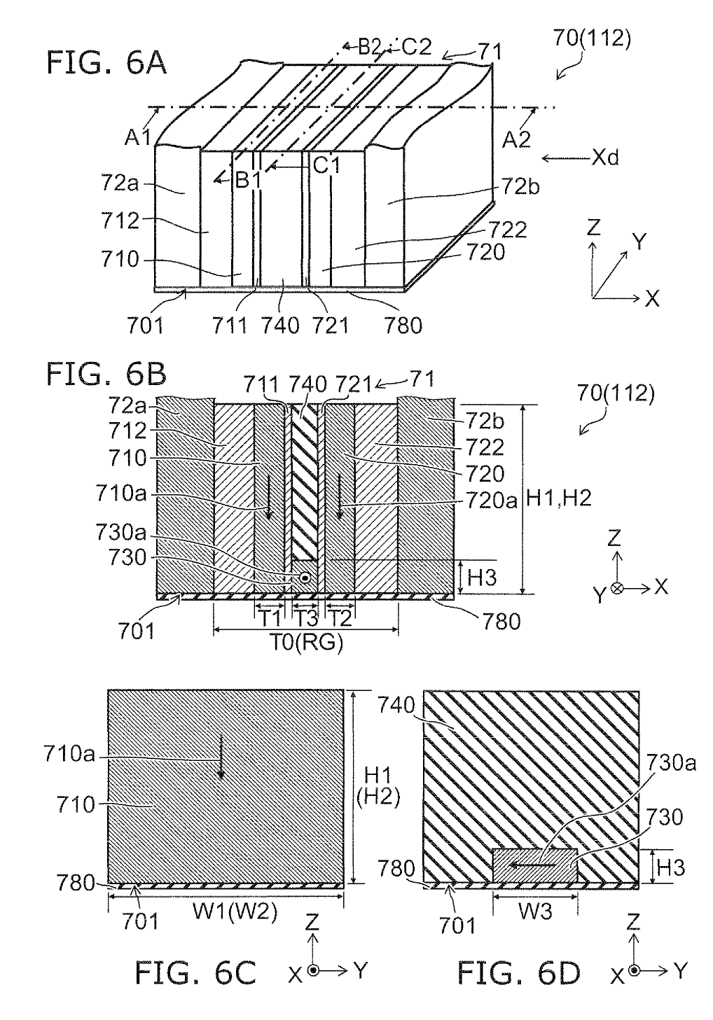

FIG. 6A to FIG. 6D are schematic views illustrating the configuration of another magnetic head according to the first embodiment.

Namely, FIG. 6A is a schematic perspective view; FIG. 6B is a cross-sectional view along line A1-A2 of FIG. 6 A; FIG. 6C is a cross-sectional view along line B1-B2 of FIG. 6 A; and FIG. 6D is a cross-sectional view along line C1-C2 of FIG. 6 A.

As illustrated to FIG. 6A to FIG. 6D, in the reproducing section 70 of the magnetic head 112 according to this embodiment, a first magnetic shield 72a and a second magnetic shield 72b are provided. The magnetoresistance effect element 71 (the first magnetic pinned layer 710, the second magnetic pinned layer 720, and the magnetic free layer 730) is provided between the first magnetic shield 72a and the second magnetic shield 72b.

For the first magnetic shield 72a and the second magnetic shield 72b, ferromagnetic materials, such as, for example, NiFe, CoFe, Co, and Fe, are used. Thereby, as described below, the reproduction waveform characteristic is improved, and the reproducing characteristics are enhanced,

In the normal CPP-MR element using a spin valve film, in order to obtain a reproducing spatial resolution, the CPP-MR element is located between two soft magnetic shield layers. The spatial resolution of the reproducing head corresponds to the space (gap length RG) of the shield layers. If the storage density increases, high spatial resolution is required. For example, it is estimate that the gap length RG of 12 nm is necessary for the storage density of 5T (Thera) bit per 1 square inch. However, in the CPP-MR element, the minimum value of the gap length RG is estimated to about 20 nm from the limit of the thickness of the element. In other words, in the CPP-MR element, a seed layer (thickness of 2 nm to 3 nm), an antiferromagnetic layer (thickness of 5 nm or more), two magnetic pinned layers (total thickness of 4 nm), a metal (Cu) layer (thickness of 2 nm), a magnetic free layer (thickness of 3 nm), and a cap layer (thickness of 2 nm to 3 nm) are stacked sequentially on one of the shield, and the other one of the shield is provided thereon. For this reason, the space of the two shields becomes 19 nm to 22 nm or more and becomes larger than the estimated value.

On the other hand, in the reproducing section 70 according to the first embodiment, the thickness T0 of the magnetoresistance effect element 71, which is the sum of the thickness T1 of the first magnetic pinned layer 710, the thickness T2 of the second magnetic pinned layer 720, the thickness T3 of the magnetic free layer 730, the thickness of the first conductive layer 711, the thickness of the second conductive layer 721, the thickness of the first antiferromagnetic layer 712, and the thickness of the second antiferromagnetic layer 722, corresponds to the gap length RG between the first magnetic shield 72a and the second magnetic shield 72b. It cannot be said that the gap length RG of the embodiment is not small compared with the conventional CPP-MR element using the spin valve film.

The relation between the magnetic free layer height H3 and the spatial resolution will now be described.

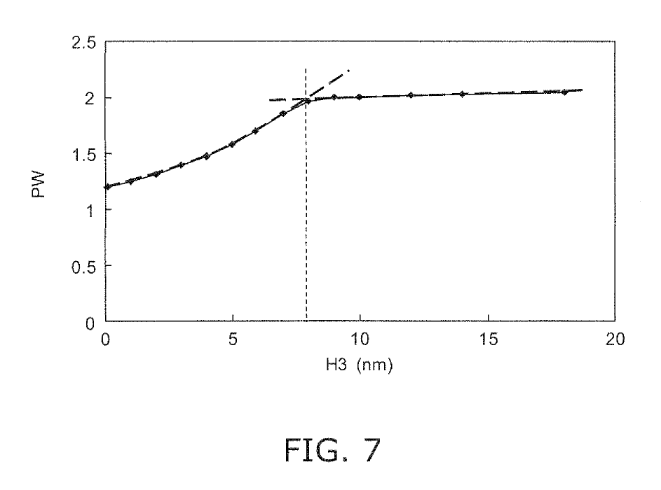

FIG. 7 is a graph illustrating characteristics of the magnetic head.

Namely, FIG. 7 illustrates simulation results of the pulse width of the differential waveform of isolated reproduction when the magnetic free layer height H3 is changed. In this simulation, the configuration of the magnetic head 112 in which the first magnetic shield 72a and the second magnetic shield 72b are provided was employed, and the gap length RG was set to 22 nm. The first magnetic pinned layer height H1 and the second magnetic pinned layer height H2 were set to 100 nm, and the first magnetic pinned layer width W1 and the second magnetic pinned layer width W2 were set to 10 nm. And, the magnetic free layer width W3 was set to 10 nm. The floating amount (Fly Height: a space between the magnetic recording medium 80 and the medium facing surface 701) was set to 4 nm.

The horizontal axis of FIG. 7 represents the magnetic free layer height H3, and the vertical axis represents the pulse width PW (the width of the pulse in the position where the isolated reproduction output shows 50% of the maximum value of the isolated reproduction pulse) of the differential waveform of the isolated reproduction. The pulse width PW corresponds to the spatial resolution of the reproducing section 70.

As illustrated in the FIG. 7, in the region where the magnetic free layer height H3 is larger than 8 nm, the pulse width PW increases gradually with the increase of the magnetic free layer height H3. However, the pulse width PW is almost constant. On the other hand, in the region where the magnetic free layer height H3 is 8 nm or less, the pulse width PW decreases remarkably with the decrease of the magnetic free layer height H3. In other words, when the magnetic free layer height H3 is 8 nm or less, the improvement in spatial resolution becomes remarkable.

Thus, it is preferable that the magnetic free layer height H3 (the length of the magnetic free layer 730 along the Z-axis direction) is 8 nm or less. Thereby, spatial resolution can be improved.

The results of FIG. 7 are simulation results of the configuration in which the first magnetic shield 72a and the second magnetic shield 72b are provided. However, the required spatial resolution can obtained in the configuration in which the first magnetic shield 72a and the second magnetic shield 72b are not provided, by setting the magnetic free layer height H3 to be small (e.g., about 8 nm or less).

In the case of the embodiment, the effect of the first magnetic shield 72a and the second magnetic shield 72b is related to the isolated reproduction waveform shape. For example, in the case where the magnetic free layer height H3 is set to 5 nm, the existence of the magnetic shield does not greatly influence the pulse width PW, which is the width of the pulse in the position where the isolated reproduction output shows 50% of the maximum value of the isolated reproduction pulse. However, for example, PW25, which is the width of the pulse in the position where the isolated reproduction output shows 25% of the maximum value of the isolated reproduction pulse, becomes smaller in the case where the magnetic shield is provided. Thereby, even if the resolution defined by the pulse width PW does not change, the final reproducing characteristics will be better in the reproducing head equipped with the magnetic shield.

In the CPP-MR element using the spin valve film, the SN ratio by the heat magnetic noise becomes large rapidly as decreasing the gap length. For example, the ratio of the heat magnetic noise to the output is 4% rms or less, which is a permissible limit value, when the gap length is 20 nm or more. However, when the gap length becomes smaller than 20 nm, the ratio increases rapidly. For example, when the gap length is 13.5 nm (corresponding to 5 Tbpi), the ratio becomes 7%, which exceeds greatly the permissible value.

On the other hand, in the magnetic head (e.g., the magnetic heads 110 to 112) according to the embodiment, a high output and a low resistance are achieved; the spin torque noise is suppressed; the degradation of the SN ratio by the heat magnetic noise is suppressed; and the spatial resolution is also high.

In the magnetic head (e.g., the magnetic heads 110 to 112) according to the embodiment, by the new configuration in which the magnetic free layer height H3 is smaller than the first magnetic pinned layer height H1 and the second magnetic pinned layer height H2, a high output and a low resistance are achieved; the spin torque noise is suppressed; and the degradation of the SN ratio by the heat magnetic noise is suppressed. The characteristics become more remarkable by making the magnetic free layer width W3 smaller than the first magnetic pinned layer width W1 and the second magnetic pinned layer width W2. Furthermore, the spatial resolution can be improved by setting the magnetic free layer height H3 appropriately (e.g., 8 nm or less).

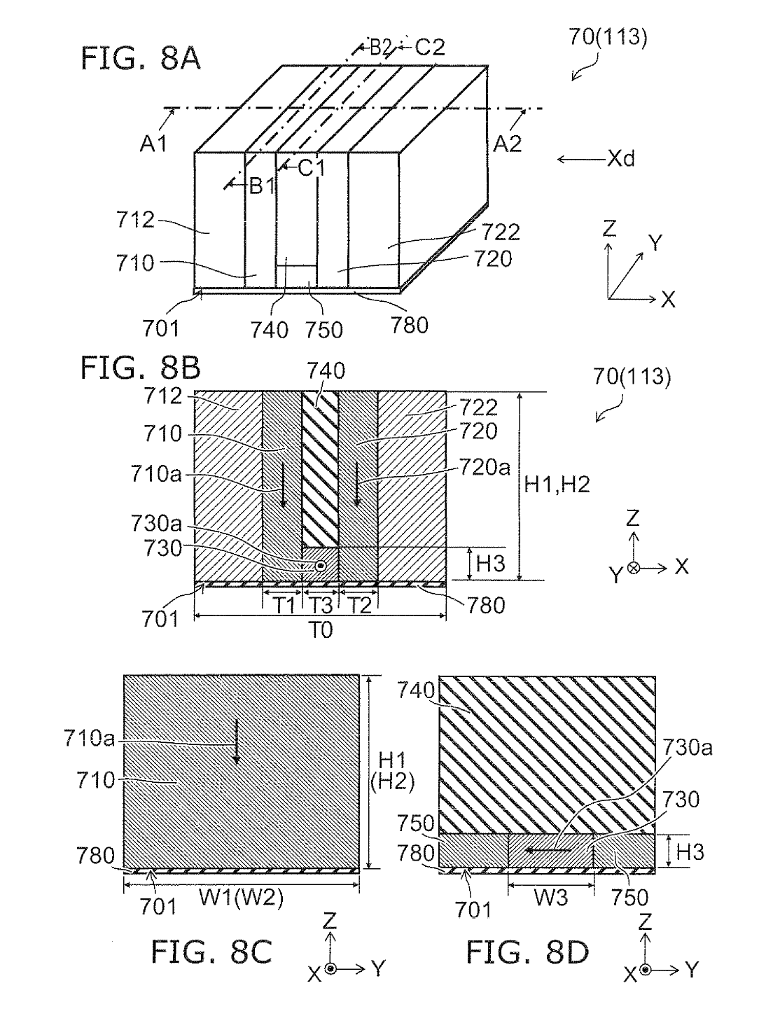

FIG. 8A to FIG, 8D are schematic views illustrating the configuration of another magnetic head according to the first embodiment.

Namely, FIG. 8A is a schematic perspective view; FIG. 8B is a cross-sectional view along line A1-A2 of FIG. 8A; FIG. 8C is a cross-sectional view along line B1-B2 of FIG. 8A; and FIG. 8D is a cross-sectional view along line C1-C2 of FIG. 8A.

As illustrated in FIG. 8A to FIG. 8D, in the reproducing section 70 of the magnetic head 113 according to this embodiment, the first conductive layer 711 and the second conductive layer 721 are omitted. A magnetic wall generated between the first magnetic pinned layer 710 and the magnetic free layer 730 and a magnetic wall generated between the second magnetic pinned layer 720 and the magnetic free layer 730 achieve the function of the first conductive layer 711 and the second conductive layer 721. In this configuration, the reproducing head of further high output and low resistance is realizable.

In the magnetic heads 110 to 113 described above, the length (the magnetic free layer width W3) of the magnetic free layer 730 along the Y-axis direction is longer than the length (the magnetic free layer height H3) of the magnetic free layer 730 along the Z-axis direction. In other words, the magnetic free layer 730 has shape anisotropy.

By using the shape anisotropy, the function of a hard bias layer can be given to the magnetic free layer 730.

In other words, in the magnetic heads 110 to 113 described above, when the length (the magnetic free layer width W3) of the magnetic free layer 730 along the Y-axis direction is longer, e.g., 1.5 times or more, than the length (the magnetic free layer height H3) of the magnetic free layer 730 along the Z-axis direction, the function as the hard bias layer in the magnetic free layer 730 becomes large. Thereby, the operation of the reproducing section 70 becomes more stable.

A hard magnetic material can be used for the magnetic free layer 730 to have the function of the hard bias layer.

In other words, in the case where the easy axis (the magnetization easy axis 730a) of the magnetic free layer 730 aligns along the Y-axis and the anisotropic magnetic field Hk of the magnetic free layer 730 is 1000 Oersteds (Oe) or more, the function as the hard bias layer in the magnetic free layer 730 becomes large. Thereby, the operation of the reproducing section 70 becomes more stable. At this time, for the material of the magnetic free layer 730, a material in which magnetic materials, such as Fe, Co, and Ni, are doped with at least one of Cr and Pt, or an artificial lattice film in which ferromagnetic thin films of Ni, Fe, etc, and thin films of Pt, Cr, etc. are stacked in four layers or more can be used.

However, in the embodiment, the hard bias layer may be further provided independently of the magnetic free layer 730.

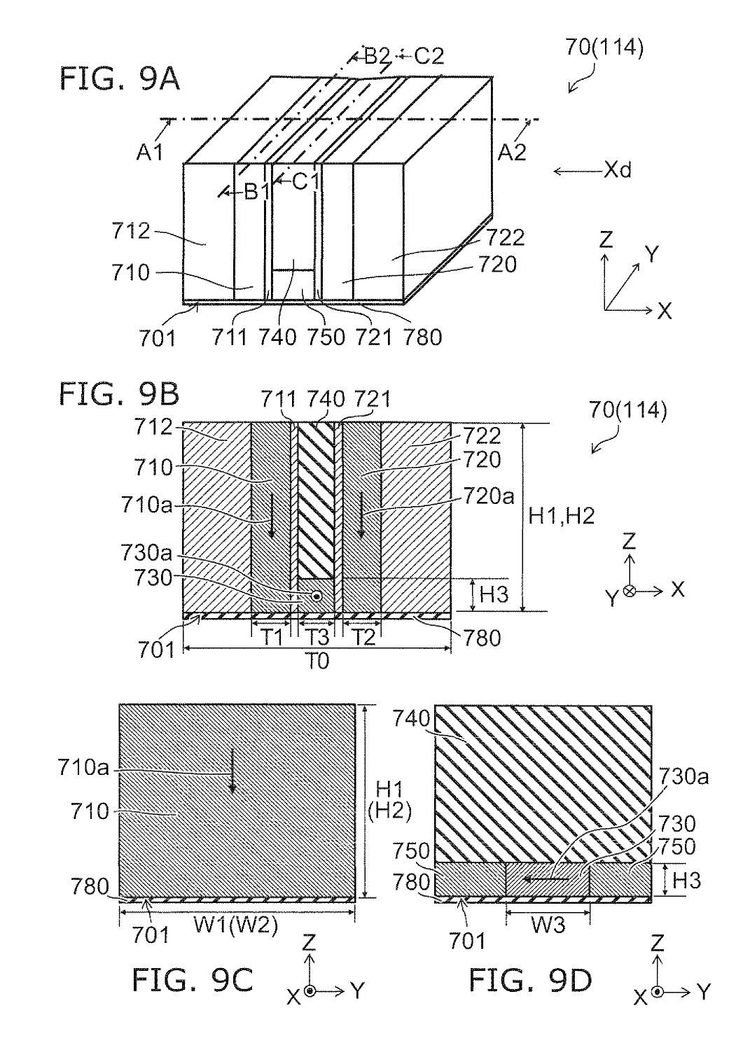

FIG. 9A to FIG. 9D are schematic views illustrating the configuration of another magnetic head according to the first embodiment.

Namely, FIG. 9A is a schematic perspective view; FIG. 9B is across-sectional view along line A1-A2 of FIG. 9A; FIG. 9C is a cross-sectional view along line B1-B2 of FIG. 9A; and FIG. 9D is a cross-sectional view along line C1-C2 of FIG. 9A.

As illustrated in FIG. 9A to FIG. 9D, in the reproducing section 70 of the magnetic head 114 according to this embodiment, the hard bias layer 750 juxtaposed with the magnetic free layer 730 along the Y-axis direction is provided. For the hard bias layer 750, materials, such as CoPt, CoCrPt, and FePt, can be used. Thereby, the operation of the reproducing section 70 can be stabilized more.

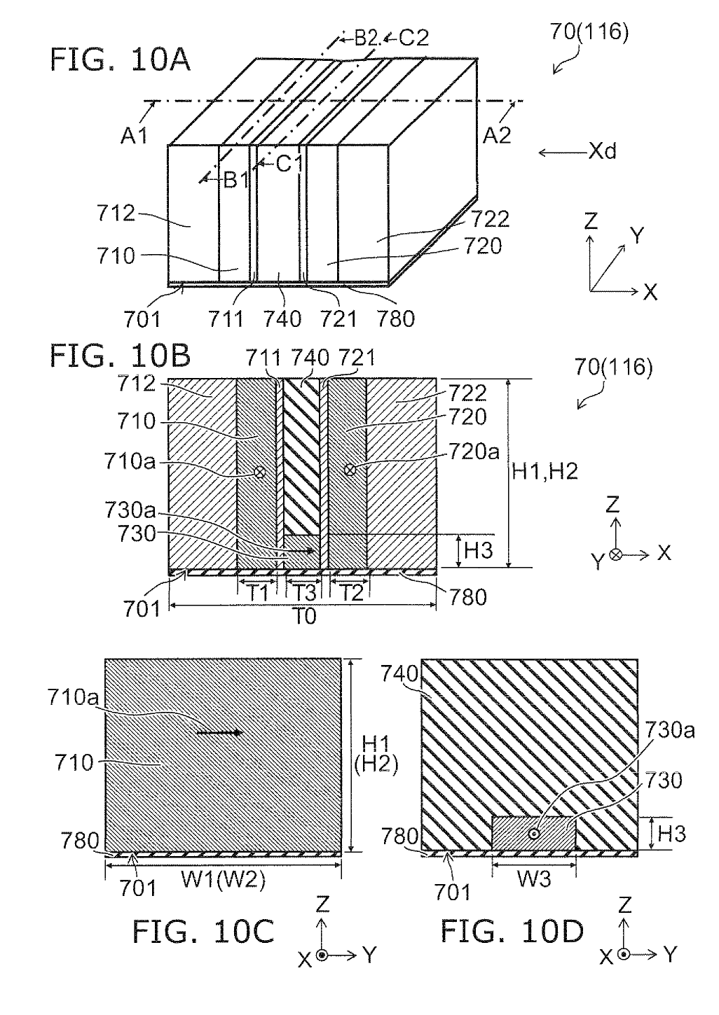

FIG. 10A to FIG. 10D are schematic views illustrating the configuration of another magnetic head according to the first embodiment.

Namely, FIG. 10A is a schematic perspective view; FIG. 10B is a cross-sectional view along line A1-A2 of FIG. 10A; FIG. 10C is a cross-sectional view along line B1-B2 of FIG. 10A; and FIG. 10D is a cross-sectional view along line C1-C2 of FIG. 10A.

As illustrated in FIG. 10A to FIG. 10D, in the reproducing section 70 of the magnetic head 116 according to this embodiment, the direction of the magnetization (the first magnetization 710a) of the first magnetic pinned layer 710 is parallel to the Y-axis direction. And, the direction of the magnetization (the second magnetization 720a) of the second magnetic pinned layer 720 is parallel to the Y-axis direction. At this time, “parallel” includes a state in which the angle between the direction of the first magnetization 710a and the Y-axis direction is plus or minus 10 degrees or less and the angle between the direction of the second magnetization 720a and the Y-axis direction is plus or minus 10 degrees or less, for example, in addition to a state in which the direction of the first magnetization 710a is strictly parallel to the Y-axis direction and the direction of the second magnetization 720a is strictly parallel to the Y-axis direction.

On the other hand, the magnetization easy axis 730a of the magnetic free layer 730 is parallel to the X-axis direction. At this time, “parallel” includes a state in which the angle between the magnetization easy axis 730a and the X-axis direction is plus or minus 20 degrees or less, for example, in addition to a state in which the magnetization easy axis 730a is strictly parallel to the X-axis direction.

Thus, in the magnetic head 116, the first magnetization 710a, the second magnetization 720a, and the magnetization easy axis 730a are rotated 90 degrees from each direction in the magnetic head 110, for example.

Also in the magnetic head 116 having such configuration, a high output and a low resistance can be achieved; the spin torque noise is suppressed; the degradation of the SN ratio by the heat magnetic noise is suppressed; and the spatial resolution can be improved.

In this case as well, the function of the hard bias layer can be provided to the magnetic free layer 730 by using a hard magnetic material for the magnetic free layer 730. In other words, in the case where the easy axis (the magnetization easy axis 730a) of the magnetization of the magnetic free layer 730 aligns along the X-axis direction and the anisotropic magnetic field Hk of the magnetic free layer 730 is 3000 Oe or more, the function as the hard bias layer in the magnetic free layer 730 becomes large. Thereby, the operation of the reproducing section 70 is stabilized more.

In this configuration, the magnetization easy axis 730a of the magnetic free layer 730 aligns along the X-axis direction. Therefore, it is difficult to provide a hard bias layer separately and to apply hard bias to the magnetic free layer 730 from the exterior of the magnetic free layer 730, Accordingly, the configuration in which the magnetic free layer 730 is to be hard magnetic (i.e., the configuration in which the anisotropic magnetic field Hk is set to 3000 Oe or more) is effective as described above.

As another configuration, a configuration can be also applied in which the direction of the magnetization (the first magnetization 710a) of the first magnetic pinned layer 710 and the direction of the magnetization (the second magnetization 720a) of the second magnetic pinned layer 720 are parallel to the X-axis direction and the magnetization easy axis 730a of the magnetic free layer 730 is parallel to the Y-axis direction, In this case as well, “parallel” to each axis includes the case where the angle with the direction to each axis are plus or minus 10 degrees or less.

In this embodiment, synthetic pinned layers may be used as a layer which functions as the first magnetic pinned layer 710. In the synthetic pinned layers, two ferromagnetic material layers are stacked via a non-magnetic layer, such as Ru, having a thickness of several angstroms. In this configuration, the ferromagnetic material layer on a side near the anti-ferromagnetic material layer 712 of the two ferromagnetic material layers may be called as a magnetic pinned layer, and the ferromagnetic material layer on a side near the magnetic free layer 730 may be called as a magnetic reference layer. Here, the magnetization of the magnetic reference layer and the magnetization of the magnetic pinned layer are pinned in the direction of 180 degrees mutually via the non-magnetic layer such as Ru. In this case, the pinning with the angle of 180 degrees includes a case where the angle is between 150 degrees and 210 degrees.

The magnetic reference layer in the synthetic pinned layers can be considered to be the first magnetic pinned layer 710, and the magnetic pinned layer in the synthetic pinned layers can be considered to be the third magnetic pinned layer. In other words, the reproducing section 70 of the magnetoresistance effect element according to the embodiment may further include a third magnetic pinned layer and the first intermediate layer. The first magnetic pinned layer 710 is disposed between the third magnetic pinned layer and the magnetic free layer 730. The direction of the magnetization of the third magnetic pinned layer is pinned in the direction anti-parallel to the direction of the magnetization of the first magnetic pinned layer (with the angle of 150 degrees or more and 210 degrees or less, as described above). The first intermediate layer is provided between the first magnetic pinned layer 710 and the third magnetic pinned layer, and is non-magnetic.

Similarly, the synthetic pinned layers may be used as a layer which functions as the second magnetic pinned layer 720. In other words, the reproducing section 70 of the magnetoresistance effect element according to the embodiment can further include a fourth magnetic pinned layer and a second intermediate layer. The second magnetic pinned layer 720 is disposed between the fourth magnetic pinned layer and the magnetic free layer 730. The direction of the magnetization of the fourth magnetic pinned layer is pinned in the direction anti-parallel to the direction of the magnetization of the second magnetic pinned layer (e.g., with the angle of 150 degrees or more and 210 degrees or less). The second intermediate layer is provided between the second magnetic pinned layer 720 and the fourth magnetic pinned layer, and is non-magnetic.

### Second Embodiment

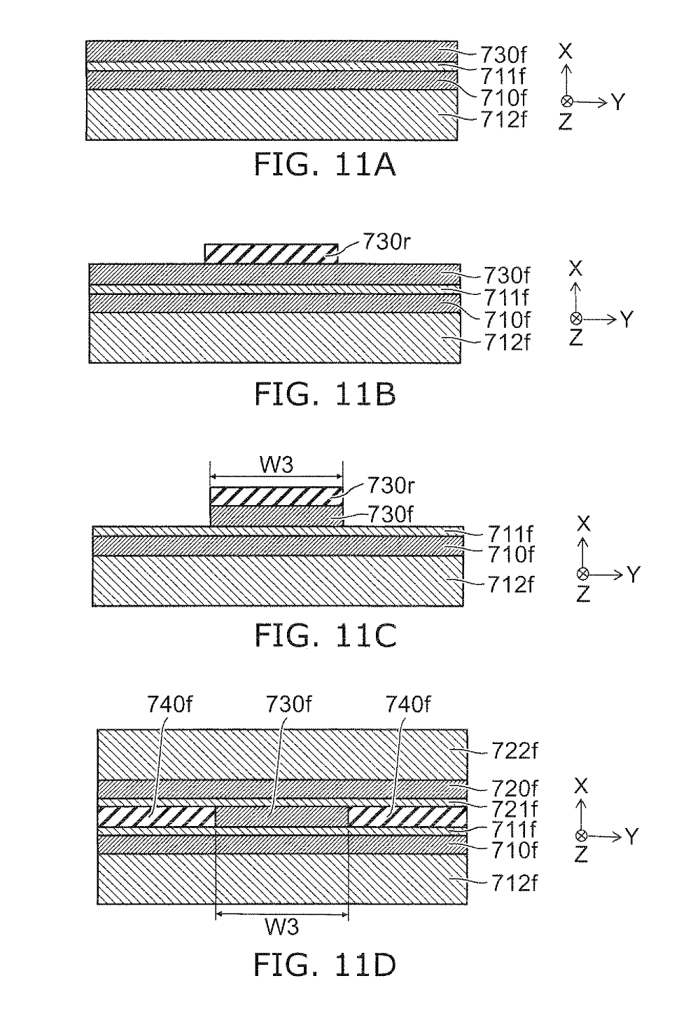

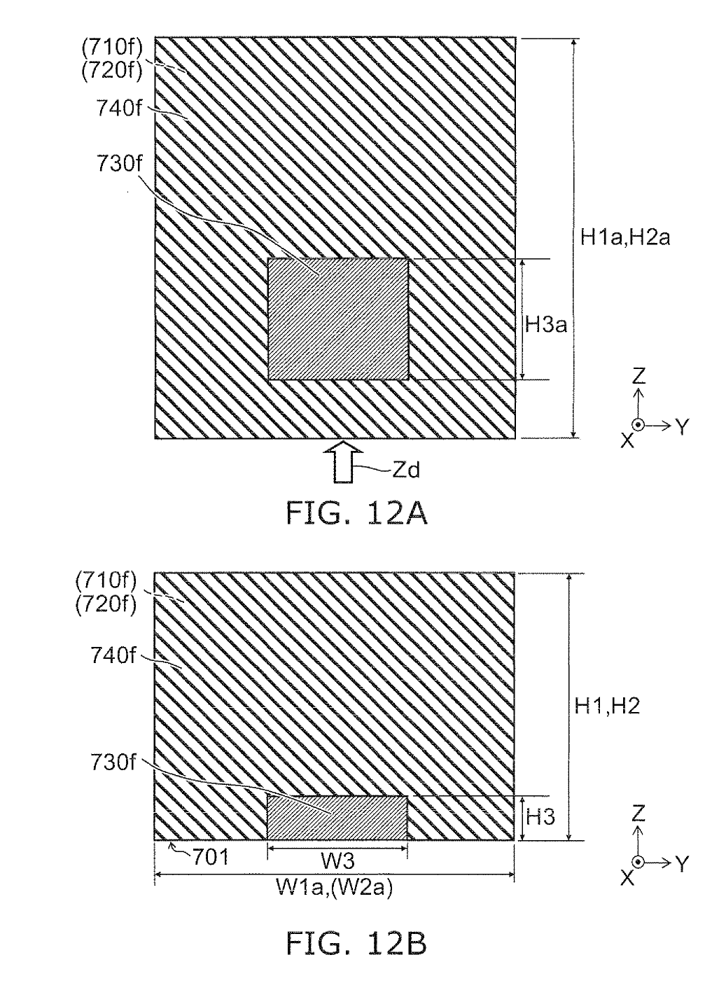

FIG. 11A to FIG. 11D are schematic cross-sectional views in order of processes illustrating a method for manufacturing a magnetic head according to a second embodiment.

FIG. 12A and FIG. 12B are schematic cross-sectional views in order of processes illustrating the method for manufacturing the magnetic head according to the second embodiment.

This manufacturing method is a manufacturing method in the case of manufacturing the magnetic head 111 explained above. FIG. 11A to FIG. 11D are cross-sectional views cutting along an X-Y plane. FIG. 12A and FIG. 12B are cross-sectional views cutting along a Y-Z plane.

As illustrated in FIG. 11A, a first antiferromagnetic film 712f serving as the first antiferromagnetic layer 712, a first magnetic pinned film 710f serving as the first magnetic pinned layer 710, a first conductive film 711f serving as the first conductive layer 711, and a magnetic free film 730f serving as the magnetic free layer 730 are stacked sequentially on, for example, a base body not illustrated.

As illustrated in FIG. 11B, a resist film 730r having a predetermined shape is formed on the magnetic free film 730f. The shape of the resist film 730r is formed by a photo lithography technology.

As illustrated in FIG. 11C, the magnetic free film 730f is processed using the resist film 730r as a mask. In this processing, a technique, such as, for example, milling etching, is used. By this processing, the width (the magnetic free layer width W3) of the magnetic free layer 730 (the magnetic free film 730f) is made smaller than the width (the first magnetic pinned layer width W1) of the first magnetic pinned layer 710 (the first magnetic pinned film 710f). At this time, as described below, the length of the magnetic free film 730f along the Z-axis direction is processed to be smaller than the length of the first magnetic pinned film 710f along the Z-axis direction. Then, the resist film 730r is removed.

As illustrated in FIG. 11D, on the magnetic free film 730f and on the first conductive film 711f, an insulating film 740f serving as the insulating layer 740 is formed. The surface is planerized and the magnetic free film 730f is exposed. And, on the magnetic free film 730f and the insulating film 740f, a second conductive film 721f serving as the second conductive layer 721, a second magnetic pinned film 720f serving as the second magnetic pinned layer 720, and a second antiferromagnetic film 722f serving as the second antiferromagnetic layer 722 are stacked sequentially. Thereby, a stacked structure body serving as the magnetoresistance effect element 71 is formed.

As illustrated in FIG. 12A, by the processing of the magnetic free film 730f described above, the width of the magnetic free film 730f along the Y-axis direction is made smaller than the width (width W1a) of the first magnetic pinned film 710f along the Y-axis direction and smaller than the width (width W2a) of the second magnetic pinned film 720f along the Y-axis direction. The width of the magnetic free film 730f along the Y-axis direction corresponds to the length (the magnetic free layer width W3) along the Y-axis direction of the magnetic free layer 730 which is the final form.

Further, by the processing of the magnetic free film 730f described above, the length (height H3a) of the magnetic free film 730f along the Z-axis direction is made smaller than the length (height H1a) of the first magnetic pinned film 710f along the Z-axis direction. And, the length (height H3a) of the magnetic free film 730f along the Z-axis direction is made smaller than the length (height H2a) of the second magnetic pinned film 720f along with the Z-axis direction. The length (height H3a) of the magnetic free film 730f along the Z-axis direction in this stage is larger than the length (the magnetic free layer height H3) along the Z-axis direction of the magnetic free layer 730 which is the final form.

The stacked structure body of this state is polished along the Z-axis direction from the end of the stacked structure body. In other words, the stacked structure body is processed mechanically along arrow Zd.

Thereby, as illustrated in FIG. 12B, the magnetic free film 730f is exposed from the edge face being polished and the magnetic free layer 730 is formed. Thereby, the length (the magnetic free layer height H3) of the magnetic free layer 730 along the Z-axis direction is made smaller than the length (the first magnetic pinned layer height H1) of the first magnetic pinned layer 710 (the first magnetic pinned film 710f) along the Z-axis direction and smaller than the length (the second magnetic pinned layer height H2) of the second magnetic pinned layer 720 (the second magnetic pinned film 720f) along the Z-axis direction. The edge face of the stacked structure body formed by this polishing (mechanical processing) becomes the medium facing surface 701.

Then, the edge face of the stacked structure body along the Y-axis direction is processed as necessary, and the first magnetic pinned layer 710 and the second magnetic pinned layer 720 are formed. Processing of the edge face of the stacked structure body along the Y-axis direction can be performed in any process between the process described in regard to FIG. 11D and the process described in regard to FIG. 12B.

Thus, the magnetic head 111 is manufactured. The other magnetic heads described in regard to the first embodiment can be also manufactured by the same method as that recited above.

In the manufacturing method described above, the length (the magnetic free layer width W3) of the magnetic free layer 730 along the Y-axis direction is controlled by etching of photo lithography. And, the length (the magnetic free layer height H3) of the magnetic free layer 730 along the Z-axis direction is controlled by polishing (mechanical processing). Since the accuracy of the mechanical processing is higher than the accuracy of photo lithography, highly precise control of the magnetic free layer height H3 is realizable at low cost using this manufacturing method.

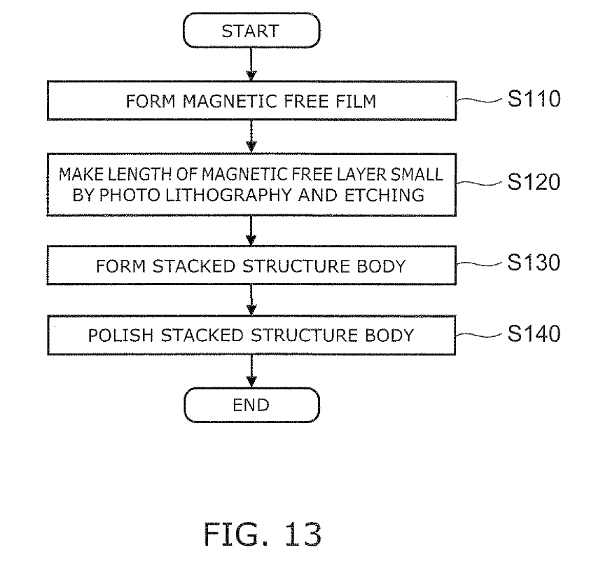

FIG. 13 is a flowchart illustrating the method for manufacturing the magnetic head according to the second embodiment.

The method for manufacturing the magnetic head according to this embodiment is a manufacturing method of the magnetic head having the medium facing surface 701 (ABS) facing the magnetic recording medium 80 and including the reproducing section 70 configured to detect the direction of the magnetization 83 recorded in the magnetic recording medium 80. The reproducing section 70 includes the first magnetic pinned layer 710, the second magnetic pinned layer 720, and the magnetic free layer 730. The direction of the magnetization of the first magnetic pinned layer 710 is pinned. The second magnetic pinned layer 720 is stacked with the first magnetic pinned layer 710 in the first direction (the X-axis direction) parallel to the medium facing surface 701, and the direction of the magnetization of the second magnetic pinned layer 720 is pinned. The magnetic free layer 730 is provided between the first magnetic pinned layer 710 and the second magnetic pinned layer 720, and the direction of the magnetization of the magnetic free layer 730 is changeable. The length (the magnetic free layer height H3) of the magnetic free layer 730 along the second direction (the Z-axis direction) perpendicular to the medium facing surface 701 is shorter than the length (the first magnetic pinned layer height H1) of the first magnetic pinned layer 710 along the second direction and shorter than the length (the second magnetic pinned layer height H2) of the second pinned layer 720 along the second direction.

As illustrated in FIG. 13, the magnetic free film 730f serving as the magnetic free layer 730 is formed on the first magnetic pinned film 710f serving as the first magnetic pinned layer 710 (Step S110). That is, for example, the processing described in regard to FIG. 11A is performed.

The length (height H3a) of the magnetic free film 730f along the second direction (the Z-axis direction) is made smaller than the length (height H1a) of the first magnetic pinned film 710f along the second direction by photo lithography and etching (Step S120). That is, for example, the processing described in regard to FIG. 11B and FIG. 11C is performed.

The second magnetic pinned film 720f serving as the second magnetic pinned layer 720 is formed on the magnetic free film 730f whose length along the second direction is decreased, and the stacked structure body including the first magnetic pinned film 710f, the magnetic free film 730f, and the second magnetic pinned film 720f is formed (Step S130). That is, for example, the processing described in regard to FIG. 11D is performed.

The stacked structure body is polished along the second direction, and the length of the magnetic free film 730f along the second direction is made smaller than the length of the first magnetic pinned film 710f along the second direction and smaller than the length of the second magnetic pinned film 720f along the second direction (Step S140). Thereby, the magnetic head is manufactured.

In the above, “forming on” includes a case of forming an upper layer above a lower layer via another layer, in addition to a case of forming the upper layer in contact with the lower layer.

The face formed by this polishing becomes the medium facing surface 701. By this polishing, the magnetic free film 730f (the magnetic free layer 730) is exposed in the medium facing surface 701.

In this manufacturing method, the length (the magnetic free layer height H3) of the magnetic free layer 730 along the Z-axis direction is controlled by two processing of the first processing (Step S120) using photo lithography and etching and the second processing (Step S140) using polishing (mechanical processing). Therefore, highly precise control of the magnetic free layer height H3 can be realized at low cost.

For example, the element width (e.g., the magnetic free layer width W3) of the magnetoresistance effect element 71 is set to about 10 nm for the storage density of 5 terabits. In the magnetic head according to the embodiment, as already explained, it is desirable to set the magnetic free layer height H3 to 8 nm or less. In other words, for securing high spatial resolution, the magnetic free layer height H3 is made smaller than the element width. At this time, by applying the method described above, the magnetic free layer height H3 can be controlled at low cost with high precision, and the practical magnetic head can be provided.

### Third Embodiment

The magnetic head according to the embodiment described above can illustratively be incorporated in an integrated recording/reproducing magnetic head assembly, which can be installed on a magnetic recording/reproducing apparatus. Here, the magnetic recording/reproducing apparatus according to the embodiment can have only a reproducing function or both recording and reproducing functions.

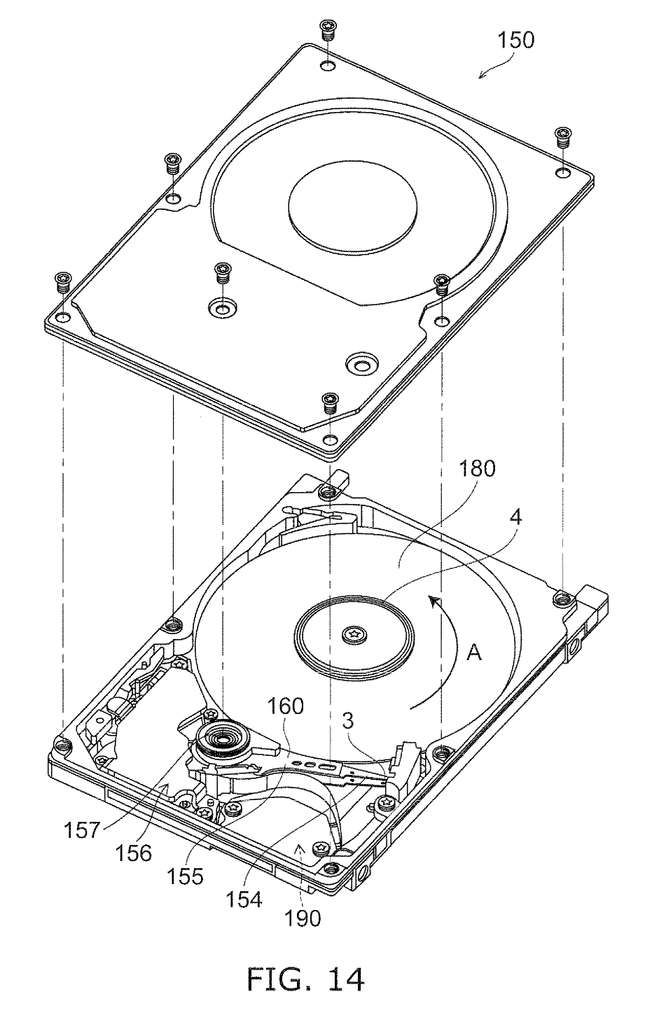

FIG. 14 is a schematic perspective view illustrating the configuration of the magnetic recording/reproducing apparatus according to the third embodiment.

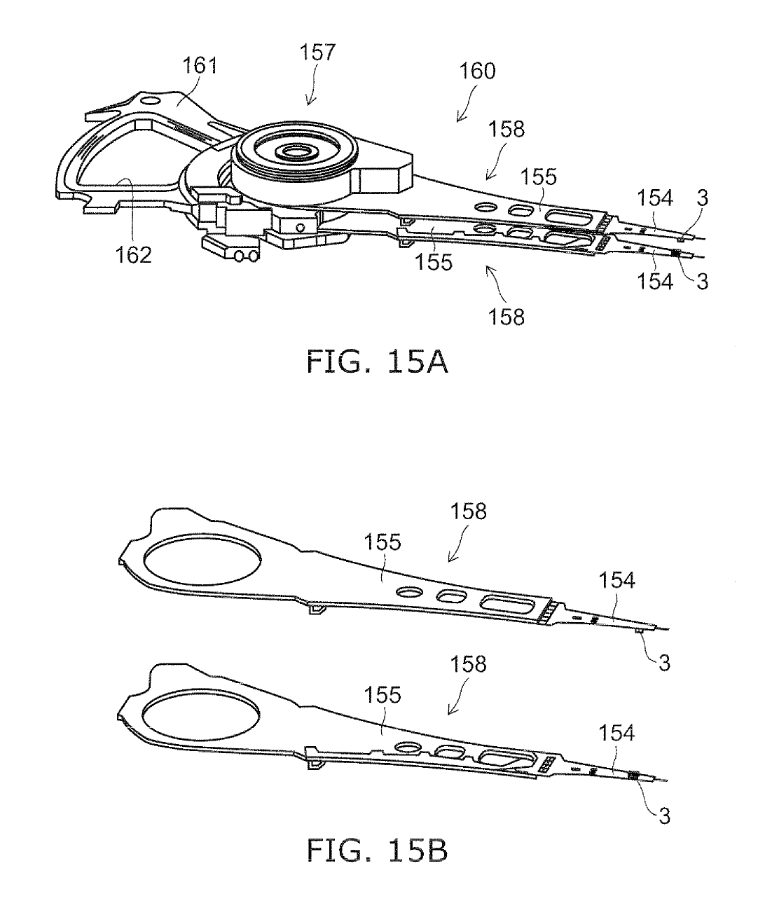

FIG. 15A and FIG. 15B are schematic perspective views illustrating the configuration of part of the magnetic recording apparatus according to the third embodiment.

As illustrated in FIG. 14, the magnetic recording/reproducing apparatus 150 according to the embodiment is an apparatus based on a rotary actuator. In this figure, a recording medium disk 180 is mounted on a spindle motor 4 and rotated in the direction of arrow A by a motor, not shown, in response to a control signal from a drive controller, not shown. The magnetic recording/reproducing apparatus 150 according to this embodiment may include a plurality of recording medium disks 180.

The head slider 3 for recording/reproducing information stored on the recording medium disk 180 has a configuration as described above, and is attached to the tip of a thin-film suspension 154. Here, for example, one of the magnetic heads (e.g., the magnetic heads 110, 111, 112, 113, 114 and 116) according to the embodiments described above is installed near the tip of the head slider 3.

When the recording medium disk 180 is rotated, the pressing pressure by the suspension 154 is balanced with the pressure generated at the medium facing surface (ABS) of the head slider 3. Thus, the medium facing surface of the head slider 3 is held at a prescribed floating amount from the surface of the recording medium disk 180. Here, the head slider 3 may be the so-called “contact-traveling type”, in which the head slider 3 is in contact with the recording medium disk 180.

The suspension 154 is connected to one end of an actuator arm 155 including a bobbin for holding a driving coil, not shown, A voice coil motor 156, which is a kind of a linear motor, is provided on the other end of the actuator arm 155. The voice coil motor 156 can include the driving coil, not shown, wound up around the bobbin of the actuator arm 155, and a magnetic circuit composed of a permanent magnet and an opposed yoke disposed to oppose across this coil.

The actuator arm 155 is held by ball bearings, not shown, provided at two positions, top and bottom, of a bearing portion 157, so that the actuator arm 155 can be slidably rotated by the voice coil motor 156. As a result, the magnetic recording head can be moved to any position on the recording medium disk 180.

FIG. 15A illustrates the configuration of part of the magnetic recording/reproducing apparatus according to this embodiment, and is an enlarged perspective view of a head stack assembly 160.

FIG. 15B is a perspective view illustrating a magnetic head assembly (head gimbal assembly: HGA) 158, which constitutes part of the head stack assembly 160.

As illustrated in FIG. 15A, the head stack assembly 160 includes a bearing portion 157, a head gimbal assembly 158 extending from this bearing portion 157, and a support frame 161 extending from the bearing portion 157 to the direction opposite from the HGA and supporting the coil 162 of the voice coil motor.

As illustrated in FIG. 15B, the head gimbal assembly 158 includes an actuator arm 155 extending from the bearing portion 157, and a suspension 154 extending from the actuator arm 155.

A head slider 3 is attached to the tip of the suspension 154. On the head slider 3, one of the magnetic heads according to the above embodiments is installed.

In other words, the magnetic head assembly (head gimbal assembly) 158 according to this embodiment includes the magnetic head according to the embodiments described above, a head slider 3 with the magnetic head installed thereon, a suspension 154 with the head slider 3 installed on one end, and an actuator arm 155 connected to the other end of the suspension 154.

The suspension 154 includes lead wires (not shown) for writing and reading signals, for a heater for adjusting the floating amount, and for, for example, the spin torque oscillator and the like. These lead wires are electrically connected to respective electrodes of the magnetic head incorporated in the head slider 3.

Furthermore, a signal processing unit 190 configured to write and read signals on the magnetic recording medium using the magnetic recording head is provided. For example, the signal processing unit 190 is provided on the rear surface side in the figure of the magnetic recording/reproducing apparatus 150 illustrated in FIG. 14. The input/output lines of the signal processing unit 190 are connected to the electrode pads of the head gimbal assembly 158 and electrically coupled to the magnetic recording head.

Thus, the magnetic recording/reproducing apparatus 150 according to this embodiment includes a magnetic recording medium, the magnetic head according to the embodiments described above, a movable unit capable of relatively moving the magnetic recording medium and the magnetic head in a spaced or contact state, a position control unit for positioning the magnetic recording head at a prescribed recording position of the magnetic recording medium, and a signal processing unit for writing and reading signals on the magnetic recording medium using the magnetic recording head.

More specifically, the recording medium disk 180 is used as the magnetic recording medium described above.

The movable unit described above can include the head slider 3.

The signal processing unit described above can include the head gimbal assembly 158.

Thus, the magnetic recording/reproducing apparatus 150 according to this embodiment includes a magnetic recording medium, the magnetic head assembly according to the embodiment, and a signal processing unit for writing and reading signals on the magnetic recording medium using the magnetic head installed on the magnetic head assembly.

In the magnetic recording/reproducing apparatus 150 according to this embodiment, by using the magnetic head according to the embodiments described above, the reproducing with a high output and a low resistance can be possible. Furthermore, the spin torque noise is suppressed; the degradation of the SN ratio by the heat magnetic noise is suppressed; and the spatial resolution can be improved.

According to the embodiment, a magnetic head, a magnetic head assembly, and a magnetic recording/reproducing apparatus including a magnetoresistive element having a high output and a low resistance are provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the invention is not limited to these specific examples. For example, one skilled in the art may similarly practice the invention by appropriately selecting specific configurations of components such as reproducing sections, magnetoresistive elements, magnetic pinned layers, magnetic free layers, antiferromagnetic layers, conductive layers, protection layers, and recording sections included in magnetic heads; head sliders, suspensions, and actuator arms included in magnetic head assemblies; and magnetic recording medium included in magnetic recording/reproducing apparatuses, and the like from known art. Such practice is included in the scope of the invention to the extent that similar effects thereto are obtained. For example, material, composition and film thickness described above in regard to embodiments are examples, and they may have variations.

Any two or more components of the specific examples may be combined within the extent of technical feasibility and are included in the scope of the invention to the extent that the purport of the invention is included.

The magnetic head, the magnetic head assembly, and the magnetic recording/reproducing apparatus described above as the embodiment of the invention can be suitably modified and practiced by those skilled in the art, and such modifications are also encompassed within the scope of the invention as long as they fall within the spirit of the invention.

Furthermore, various modifications and alterations within the spirit of the invention will be readily apparent to those skilled in the art. All such modifications and alterations should therefore be seen as within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic head, comprising:
a reproducing section having a medium facing surface facing a magnetic recording medium, the reproducing section being configured to detect a direction of magnetization being recorded in the magnetic recording medium,
the reproducing section including:
a first magnetic pinned layer, a direction of magnetization of the first magnetic pinned layer being pinned,
a second magnetic pinned layer stacked with the first magnetic pinned layer in a first direction parallel to the medium facing surface, a direction of magnetization of the second magnetic pinned layer being pinned, and
a magnetic free layer provided between the first magnetic pinned layer and the second magnetic pinned layer, a direction of magnetization of the magnetic free layer being changeable,
a length of the magnetic free layer along a second direction perpendicular to the medium facing surface being shorter than a length of the first magnetic pinned layer along the second direction and shorter than a length of the second pinned layer along the second direction.

2. The head according to claim 1, wherein an edge of the first magnetic pinned layer on a side of the medium facing surface, an edge of the second magnetic pinned layer on the side of the medium facing surface, and an edge of the magnetic free layer on the side of the medium facing surface are located in a plane including the medium facing surface.

3. The head according to claim 1, wherein a length of the magnetic free layer along a third direction perpendicular to the first direction and the second direction is shorter than a length of the first magnetic pinned layer along the third direction and shorter than a length of the second magnetic pinned layer along the third direction.

4. The head according to claim 1, wherein a length of the magnetic free layer along a third direction perpendicular to the first direction and the second direction is longer than the length of the magnetic free layer along the second direction.

5. The head according to claim 1, wherein the length of the magnetic free layer along the second direction is not more than 8 nanometers.

6. The head according to claim 1, wherein an easy axis of the magnetization of the magnetic free layer aligns along a third direction perpendicular to the first direction and the second direction, and an anisotropic magnetic field of the magnetic free layer is not smaller than 1000 Oersteds.

7. The head according to claim 1, wherein an easy axis of the magnetization of the magnetic free layer aligns along the first direction, and an anisotropic magnetic field of the magnetic free layer is not smaller than 3000 Oersteds.

8. The head according to claim 1, wherein the reproducing section further includes a hard bias layer provided between the first magnetic pinned layer and the second magnetic pinned layer and juxtaposed with the magnetic free layer in a plane perpendicular to the first direction.

9. The head according to claim 1, wherein the direction of the magnetization of the first magnetic pinned layer and the direction of the magnetization of the second magnetic pinned layer are perpendicular to the first direction.

10. The head according to claim 9, wherein the direction of the magnetization of the first magnetic pinned layer is parallel to the direction of the magnetization of the second magnetic pinned layer.

11. The head according to claim 1, wherein an easy axis of the magnetization of the magnetic free layer is perpendicular to the direction of the magnetization of the first magnetic pinned layer and is perpendicular to the direction of the magnetization of the second magnetic pinned layer.

12. The head according to claim 1, wherein
a thickness of the first magnetic pinned layer is not less than 1 nanometer and not more than 10 nanometers;
a thickness of the second magnetic pinned layer is not less than 1 nanometer and not more than 10 nanometers; and
a thickness of the magnetic free layer is not less than 1 nanometer and not more than 10 nanometers.

13. The head according to claim 1, wherein a length of the magnetic free layer along a third direction perpendicular to the first direction and the second direction is shorter than a length of the first magnetic pinned layer along the third direction and shorter than a length of the second magnetic pinned layer along the third direction

14. The head according to claim 1, wherein a length of the first magnetic pinned layer along a third direction perpendicular to the first direction and the second direction and a length of the second magnetic pinned layer along the third direction are not less than 4 nanometers and not more than 200 nanometers.

15. The head according to claim 1, wherein an easy axis of the magnetization of the magnetic free layer intersects with the direction of the magnetization of the first magnetic pinned layer and intersects with the direction of the magnetization of the second magnetic pinned layer.

16. The head according to claim 1, wherein a length of the first magnetic pinned layer along the second direction and a length of the second magnetic pinned layer along the second direction are not more than 200 nanometers.

17. The head according to claim 1, wherein a length of the magnetic free layer along a third direction perpendicular to the first direction and the second direction is not less than 1.5 times a length of the magnetic free layer along the second direction.

18. The head according to claim 1, wherein the first magnetic pinned layer has a configuration of synthetic pinned layers.

19. A magnetic head assembly comprising:
a magnetic head, including:
a reproducing section having a medium facing surface facing a magnetic recording medium, the reproducing section being configured to detect a direction of magnetization being recorded in the magnetic recording medium,
the reproducing section including:
a first magnetic pinned layer, a direction of magnetization of the first magnetic pinned layer being pinned,
a second magnetic pinned layer stacked with the first magnetic pinned layer in a first direction parallel to the medium facing surface, a direction of magnetization of the second magnetic pinned layer being pinned, and
a magnetic free layer provided between the first magnetic pinned layer and the second magnetic pinned layer, a direction of magnetization of the magnetic free layer being changeable,
a length of the magnetic free layer along a second direction perpendicular to the medium facing surface being shorter than a length of the first magnetic pinned layer along the second direction and shorter than a length of the second pinned layer along the second direction;
a suspension installing the magnetic head on one end of the suspension; and
an actuator arm connected to one other end of the suspension.

20. A magnetic recording/reproducing apparatus comprising:
a magnetic head assembly, including:
a magnetic head, including:
a reproducing section having a medium facing surface facing a magnetic recording medium, the reproducing section being configured to detect a direction of magnetization being recorded in the magnetic recording medium,
the reproducing section including:
a first magnetic pinned layer, a direction of magnetization of the first magnetic pinned layer being pinned,
a second magnetic pinned layer stacked with the first magnetic pinned layer in a first direction parallel to the medium facing surface, a direction of magnetization of the second magnetic pinned layer being pinned, and
a magnetic free layer provided between the first magnetic pinned layer and the second magnetic pinned layer, a direction of magnetization of the magnetic free layer being changeable,
a length of the magnetic free layer along a second direction perpendicular to the medium facing surface being shorter than a length of the first magnetic pinned layer along the second direction and shorter than a length of the second pinned layer along the second direction;
a suspension installing the magnetic head on one end of the suspension; and
an actuator arm connected to one other end of the suspension; and
the magnetic recording medium having information to be reproduced by using the magnetic head installed on the magnetic head assembly.
